(19) United States
(12) Patent Application Publication
(10) Pub. No.: US 2011/0096931 A1
(43) Pub. Date: Apr. 28, 2011

(54) CROSSTALK SUPPRESSION

(75) Inventor: Mats ORMIN, Malmo (SE)

(73) Assignee: SONY ERICSSON MOBILE COMMUNICATIONS AB, Lund (SE)

(21) Appl. No.: 12/607,363

(22) Filed: Oct. 28, 2009

(51) Int. Cl. H04R 5/00; H04B 15/00; H04R 29/00

(52) U.S. Cl. 381/22; 381/71.1; 381/94.1; 455/570; 381/58

(57) ABSTRACT

A crosstalk suppression arrangement for a stereo audio system, wherein the stereo audio system comprises a left stereo channel and a right stereo channel, each comprising a driving circuit, an output impedance of the driving circuit comprising at least a first output impedance part, and a load impedance, and wherein the load impedances of the left and the right stereo channels are connected to a reference voltage via a common reference voltage impedance, the crosstalk suppression arrangement comprising: a crosstalk suppression impedance having an impedance value based on the reference voltage impedance, at least one of the load impedances and at least one of the output impedances, wherein the crosstalk suppression impedance is connected at one end to a point between the load impedance and the output impedance of the left stereo channel and at another end to a point between the load impedance and the output impedance of the right stereo channel.

### TECHNICAL FIELD

The present invention relates generally to the field of crosstalk suppression. More particularly, it relates to suppression of crosstalk in applications where the rendering loads of two channels share a common impedance to a reference voltage.

### BACKGROUND

When two audio channels share a common impedance to a reference voltage (such as, for example, a common ground impedance), crosstalk can occur between the channels. An example of this phenomenon is illustrated in FIGS. 1A and 1B for a stereo audio application having two audio channels: the left channel—L, and the right channel—R.

The output impedances 101, 102 of left and right channel driving circuits are denoted Z_{out,L} and Z_{out,R} respectively. The load impedances 103, 104 of the left and right channel rendering (e.g. earphones, headphones, or other loadspeaker arrangement) are denoted Z_{load,L} and Z_{load,R} respectively and are typically connected in series to the respective output impedances via connection points 108, 109 as is shown in FIG. 1A.

In the setup of FIG. 1A, the load impedances 103, 104 are connected to ground via connection point 107 and a common ground impedance 105, denoted Z_{gnd}.

In FIG. 1A, the connection points 107, 108, 109 symbolize contact points between an audio rendering device (such as a personal hands free device) comprising the load impedances 104, 103 and an audio processing device (such as a mobile telephone).

It is noted that the situation in FIG. 1A is merely an example of when cross talk between channels may occur. Other applicable examples include an arrangement where load impedances of different channels are connected to a common reference voltage other than ground via a common impedance. Embodiments of the invention are equally applicable to such scenarios. The common reference voltage could, for example, be any voltage value between a positive rail and ground.

Typically, the ground impedance (or, more generally, the common reference voltage impedance) is mainly located in the audio processing device as illustrated in FIG. 1A. However, in some scenarios the common reference voltage impedance may be located in the audio rendering device or partly in the audio processing device and partly in the audio rendering device.

FIG. 1B illustrates a circuit corresponding to that of FIG. 1A as it is seen when an audio signal is fed from the driving circuit of one of the channels (left channel in this example), via the corresponding output impedance 101, through the load impedance 103 of that channel. In such a situation, crosstalk of the left channel signal may occur in the load impedance 104 of the other channel (right channel in this example) if there is a common ground impedance 105 (or, more generally, a common reference voltage impedance). This is due to the fact that the driving circuit of the opposite channel (right channel in this example) is experienced as having zero potential (i.e. virtual ground) as illustrated in FIG. 1B. In the more general case of a common reference voltage, the driving circuit of the opposite channel is experienced as having a potential equal to the reference voltage. In FIG. 1B, the crosstalk phenomenon is illustrated by a crosstalk current 110, denoted I_{ct}.

A larger value of Z_{gnd} yields more severe crosstalk between the channels, which in general worsens the audio rendering performance (and the listening experience for a user).

It should be noted that crosstalk problems do not only arise in the situation illustrated in FIG. 1A, but may appear in any situation when two audio channels share a common reference voltage impedance.

Thus, there is a need for arrangements and methods that cancel, or at least suppress, crosstalk between channels in audio applications where different channels share a common reference voltage impedance.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof.

It should also be noted that crosstalk cancellation may be viewed as a special case of crosstalk suppression, i.e. the case when the suppression is optimal. Thus, when the term “suppression” is used in this specification, it is taken to include the special case “cancellation”.

It is an object of the invention to obviate at least some of the above disadvantages and to provide arrangements and methods that cancel, or at least suppress, crosstalk between channels in audio applications where different channels share a common reference voltage impedance.

According to a first aspect of the invention, this is achieved by a crosstalk suppression arrangement for a stereo audio system, wherein the stereo audio system comprises a left stereo channel and a right stereo channel, each comprising a driving circuit, an output impedance of the driving circuit comprising at least a first output impedance part and a load impedance connected in series with the output impedance, and wherein the load impedances of the left and the right stereo channels are connected to a reference voltage via a common reference voltage impedance. The crosstalk suppression arrangement comprises a crosstalk suppression impedance having an impedance value which is based on the reference voltage impedance, at least one of the load impedances and at least one of the output impedances. The crosstalk suppression impedance is connected at one end to a point between the load impedance and the output impedance of the left stereo channel and at another end to a point between the load impedance and the output impedance of the right stereo channel.

In some embodiments, the reference voltage may be a zero voltage (i.e. ground).

In some embodiments, the impedance value, Z_{cf}, of the crosstalk suppression impedance may satisfy Z_{cf}=f₁(Z_{load,L};Z_{load,R})f₂(Z_{out,L};Z_{out,R})/Z_{g}, where f₁ is a first mathematical function, f₂ is a second mathematical function, Z_{load,L} and Z_{load,R} denote the load impedances of the left and right stereo channel respectively, Z_{out,L} and Z_{out,R} denote the output impedances of the left and right stereo channel respectively, and Z_{g} denotes the reference voltage impedance. In some of these embodiments, each of the first and second mathematical functions may comprise one of: a mathematical maximum function, a mathematical minimum function and a mathematical average function.

The crosstalk suppression arrangement may further comprise one or more sensors adapted to measure at least one of the output impedances, the load impedances, and the reference voltage impedance. The crosstalk suppression impedance may be an adaptive impedance unit.

In some embodiments, each of the output impedances may further comprise a second output impedance part in series with the first output impedance part.

In some embodiments, the arrangement may further comprise the first output impedance parts of the left and right stereo channels.

The crosstalk suppression arrangement may further comprise one or more output impedance sensors adapted to measure the second output impedance parts. The first output impedance parts may be adaptive impedances.

In some embodiments, the crosstalk suppression impedance may comprise a first crosstalk suppression impedance part in parallel with a second crosstalk suppression impedance part.

A second aspect of the invention is an audio rendering device comprising the load impedances of the left and the right stereo channels and at least part of the crosstalk suppression arrangement of the first aspect. The audio rendering device may be a personal hands free device or a headphone device.

A third aspect of the invention is an audio processing device comprising the driving circuits of the left and right stereo channels and at least part of the crosstalk suppression arrangement of the first aspect. The audio processing device may be a mobile communication device.

A fourth aspect of the invention is a method to suppress crosstalk for a stereo audio system, wherein the stereo audio system comprises a left stereo channel and a right stereo channel, each comprising a driving circuit, an output impedance of the driving circuit comprising at least a first output impedance part and a load impedance connected in series with the output impedance, and wherein the load impedances of the left and the right stereo channels are connected to a reference voltage via a common reference voltage impedance. The crosstalk suppression method comprises applying a crosstalk suppression impedance having an impedance value which is based on the reference voltage impedance, at least one of the load impedances and at least one of the output impedances, between a connection point between the load impedance and the output impedance of the left stereo channel and a connection point between the load impedance and the output impedance of the right stereo channel.

In some embodiments, the second, third and fourth aspects of the invention may additionally have features identical with or corresponding to any of the various features as explained above for the first aspect of the invention.

An advantage of some embodiments of the invention is that crosstalk can be cancelled or at least suppressed in stereo applications.

Another advantage of some embodiments of the invention is that a cheap, simple and robust crosstalk suppression arrangement is provided.

Another advantage of some embodiments of the invention is that a crosstalk suppression arrangement is provided that does not increase current consumption.

Another advantage of some embodiments of the invention is that components associated with the crosstalk suppression arrangement need not have exceptional characteristics, and may thus be acquired at low cost.

### BRIEF DESCRIPTION OF THE DRAWINGS

Further objects, features and advantages of the invention will appear from the following detailed description of embodiments of the invention, with reference being made to the accompanying drawings, wherein use of the same reference number indicates corresponding components and features, in which:

FIG. 1A is a schematic circuit diagram illustrating a stereo audio arrangement;

FIG. 1B is a schematic circuit diagram illustrating a circuit corresponding to the stereo audio arrangement of FIG. 1A as seen by the driving circuit of the left channel;

FIG. 2A a schematic circuit diagram illustrating an example arrangement according to some embodiments of the invention;

FIG. 2B a schematic circuit diagram illustrating calculation of a cross feed impedance value according to some embodiments of the invention;

FIGS. 3A-D are schematic circuit diagrams illustrating various example arrangements according to some embodiments of the invention;

FIG. 4 is a schematic drawing illustrating a mobile terminal and a mobile terminal accessory in the form of a personal hands free device, wherein the mobile terminal and/or the personal hands free device may comprise arrangements according to some embodiments of the invention; and

FIG. 5 is a flowchart illustrating example method steps according to some embodiments of the invention.

### DETAILED DESCRIPTION

In the following, embodiments of the invention will be described where a cross feed impedance is used to suppress (or optimally cancel) crosstalk in stereo audio systems.

As explained above, crosstalk between left and right stereo channels may occur when the channels (e.g. the return path from the channels) share a common ground impedance or, more generally, a common reference voltage impedance. The crosstalk is especially noticeable when driving low impedance loads such as headphones, earphones, and personal hands free devices. The crosstalk appears in opposite phase between the channels, i.e. an in-phase signal in one channel will generate a current in the load of the other channel in the opposite direction compared to a current generated by an in-phase signal from the other channel's source.

Suppressing/canceling of the crosstalk is one parameter that improves the listening experience of a user, and it may also be important to manufacturers and others due to specified performance requirements.

The common reference voltage impedance may, for example, comprise a contact resistance in the system connector (audio jack between e.g. mobile phone and hands free device).

One way to minimize the crosstalk may be to try to cancel or suppress it. Some applications use signal processing (e.g. in a DSP—digital signal processor) to estimate the crosstalk signal and produce a crosstalk suppression signal that may be fed in the opposite channel. Such solutions have several drawbacks. They are generally quite complex and power consuming. Having low power consumption may be particularly important for mobile devices. Therefore, it may be desirable to not have to use DSP processing and associated signal transportation in connection with some audio applications (e.g. FM radio rendering). Instead it may be beneficial in terms of power consumption to have a purely analog loop for these audio applications. Furthermore, the hardware and/or software platform used to build the mobile device may not have support for audio signal transport to a DSP, in which case these kinds of solutions are non-feasible.

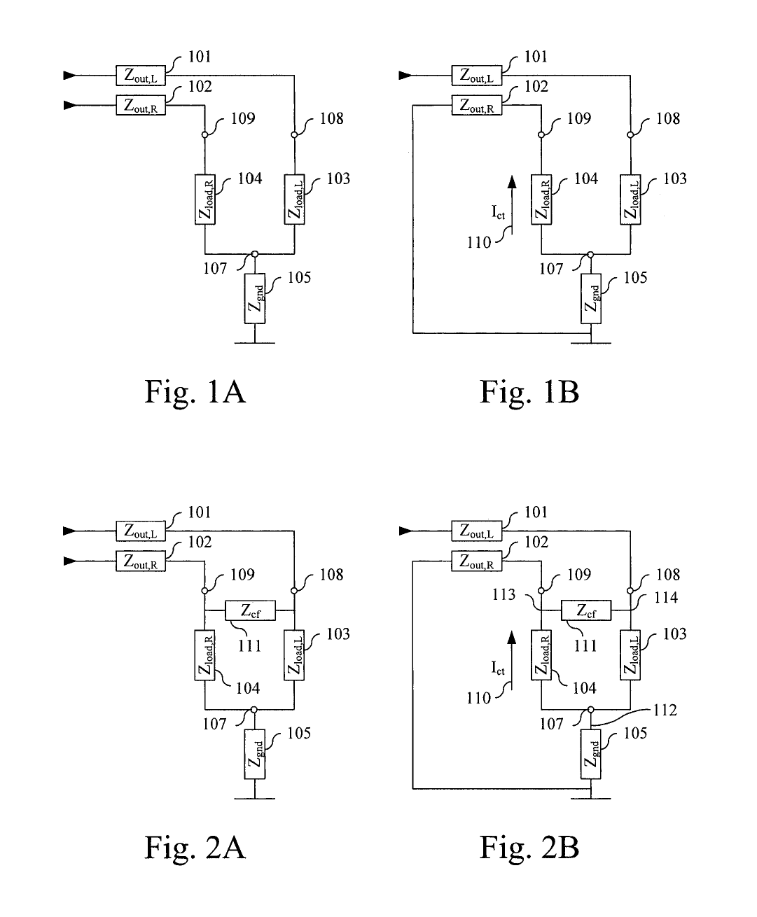

Embodiments of the invention cancel (or at least suppress) crosstalk via use of a cross feed impedance. The cross feed impedance is applied between the two stereo channels and is connected to the respective channel at a point between the load impedance and the output impedance of the channel. This principle is illustrated in FIG. 2A, where the output impedances 101, 102, the load impedances 103, 104, the connection points 107, 108, 109, and the common ground impedance 105 corresponds to those described in connection to FIG. 1A. As can be seen in FIG. 2A, a cross feed impedance 111, denoted Z_{cf} has been applied between the two channels.

To cancel the crosstalk, the choice of impedance value for the impedance 111 should be considered. FIG. 2B is a schematic circuit diagram corresponding to that of FIG. 1B, but with the cross feed impedance 111 added. The purpose of the crosstalk cancellation/suppression process is typically to minimize the current 110 (ideally so that I_{ct}=0). Thus, starting from the setup in FIG. 2B and denoting the potentials at points 112, 113 and 114 by V₁, V₂ and V₃ respectively, the conditions for crosstalk cancellation becomes:

I_{ct}=(V₁−V₂)/Z_{load,R}=0

(V₃−V₁)/Z_{load,L}=V₁/Z_{gnd}(V₁−V₂)/Z_{load,R}

(V₃−V₁)/Z_{cf}+(V₁−V₂)/Z_{load,R}=V₂/Z_{out,R}

Solving this system of equations for Z_{cf} yields

Z_{cf}=Z_{out,R}Z_{load,L}/Z_{gnd}

which is, thus, the optimal impedance value to apply to suppress/cancel crosstalk from the left channel to the right channel. Corresponding principles apply to crosstalk cancellation/suppression from the right channel to the left channel.

In some embodiments, there may be a difference between the output impedances of the different channels and/or between the load impedances of the different channels. In such situations, a trade-off must be made between left-to-right crosstalk suppression and right-to-left crosstalk suppression (due to that two “optimal” values of Z_{cf} are under consideration). One way to make this trade-off is to pick a Zₒᵤₜ randomly from Z_{out,L} and Z_{out,R}, and a Z_{load} randomly from Z_{load,L} and Z_{load,R}, and then apply Z_{cf}=ZₒᵤₜZ_{load}/Z_{gnd}. Another way is to pick Zₒᵤₜ=Z_{out,L} and a Z_{load}=Z_{load,R} or vice versa. Other alternatives include, but are not limited to:

Zₒᵤₜ=max(Z_{out,L},Z_{out,R}),

Z_{load}=max(Z_{load,L},Z_{load,R}),

Zₒᵤₜ=min(Z_{out,L},Z_{out,R}),

Z_{load}=min(Z_{load,L},Z_{load,R}),

Zₒᵤₜ=(Z_{out,L}+Z_{out,R})/2,

Z_{load}=(Z_{load,L}+Z_{load,R})/2.

Naturally, other alternatives also exist, e.g. the more general functions:

Zₒᵤₜ=AZ_{out,L}+BZ_{out,R},

Z_{load}=CZ_{load,L}+DZ_{load,R}.

The cross feed impedance may be a pure resistance, inductance or capacitance, or it may be a combination of two or more of these impedance components. Furthermore, the cross feed impedance may be built up by a single component or by several components in any suitable configuration (e.g. components in series, in parallel, or a combination thereof). The cross feed impedance may be built up by discrete components. Alternatively, it may be (partly or fully) comprised in an integrated circuit or printed circuit board.

Using the above-presented value for the cross feed impedance and provided that the output impedances of the different channels are equal and that the load impedances of the different channels are equal, the crosstalk is theoretically completely cancelled. Even in situations with slight impedance mismatch the channel separation is significantly increased by applying the cross feed impedance.

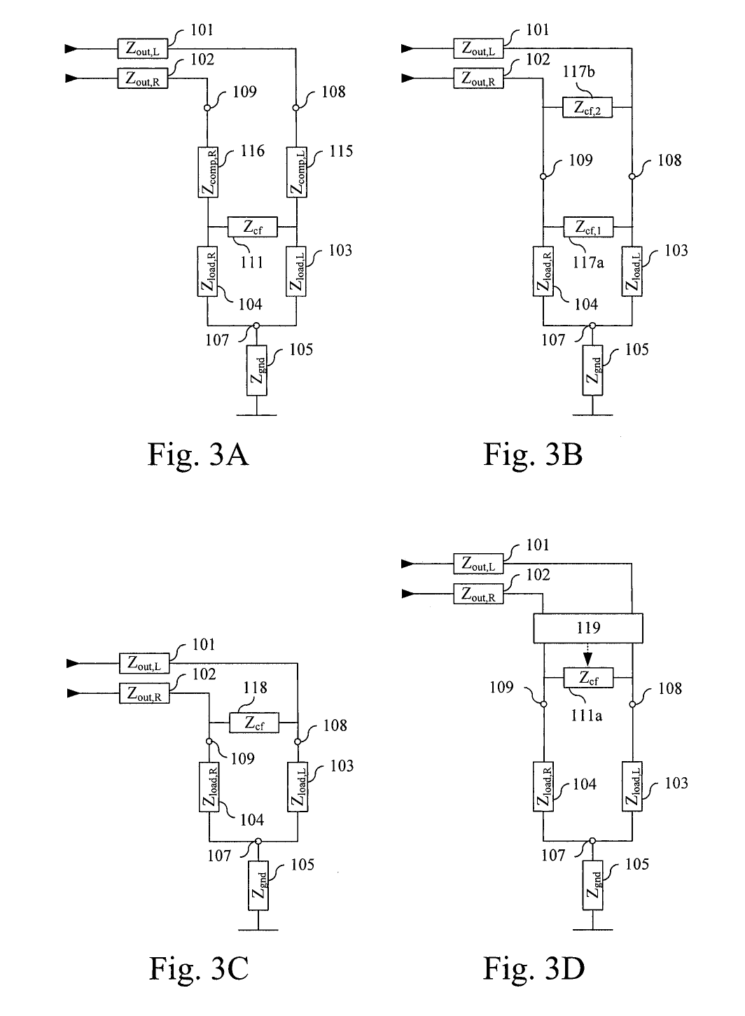

FIGS. 3A-D illustrates various embodiments of the invention in schematic circuit diagrams.

From the equations presented above it can be realized that if the output impedances of the driving circuits of the respective channels is zero or very small the cross feed impedance setup will be inferior or even unworkable. In such situations, embodiments of the invention may apply additional impedances to compensate for the non-existent or minimal output impedance. Such a setup is shown in FIG. 3A, where the output impedances 101, 102 are supplemented by compensation impedances 115, 116 applied in series with the respective output impedance 101, 102. Thus, the “output” impedance of each channel may be viewed as having first and second impedance parts connected in series via connection points 108, 109 respectively. The compensation impedances may, for example, be chosen to have an impedance value that is in the same order of magnitude as the load impedance value.

In a typical application of embodiments of the invention, the cross feed impedance (and the compensation impedances if applicable) is comprised in an audio rendering device (e.g. a personal hands free device). Then the impedance value of the cross feed may easily be optimized for the load impedance of that particular audio rendering device.

However, it should be noted that the cross feed impedance (and the compensation impedances if applicable) may alternatively be comprised (partly or fully) in an audio processing device (e.g. a mobile phone). Two examples of such situations are illustrated in FIG. 3B-C.

In FIG. 3B, the cross feed impedance comprises two impedances 117a, 117b connected in parallel. The impedance 117a, denoted Z_{cf,1} is comprised in an audio rendering device and the impedance 117b, denoted Z_{cf,2} is comprised in an audio processing device. Ideally, the values of Z_{cf,1} and Z_{cf,2} in this implementation are chosen such that Z_{cf,1}//Z_{cf,2}=_{cf,1}Z_{cf,2}/(Z_{cf,1}+Z_{cf,2})Z_{cf}=ZₒᵤₜZ_{load}/Z_{gnd}.

In some embodiments Z_{cf,1} is chosen such that Z_{load} has a minimal impact on the value of Z_{cf,1}, and Z_{cf,2} is chosen such that Zₒᵤₜ has a minimal impact on the value of Z_{cf,2}. The latter choice renders possible a setup where the components of the audio rendering device depends as little as possible of the components of the audio processing device and vice versa.

In FIG. 3C, the cross feed impedance 118 is completely comprised in an audio processing device.

FIG. 3D illustrates an example circuit corresponding to a setup where the cross feed impedance 111a is completely comprised in an audio processing device. Furthermore, the cross feed impedance 111a is an adaptive impedance in this embodiment (e.g. in the form of a potentiometer, a FET transistor or other variable impedance and similar components). In this embodiment, a measuring circuit 119 (e.g. one or more impedance sensors) is included in the audio processing device. The measuring circuit 119 is adapted to measure the load impedance 103, 104 of the audio rendering device, e.g. by sending a signal and measuring the corresponding current (for example, measuring a voltage drop over the load impedance). The measured value is then used to set the value of the adaptive impedance 111a. This setup is particularly useful if the audio processing device is used in connection with several different audio rendering devices which may have differing load impedances.

It should be noted that the principles of measuring and adapting impedances, illustrated by the example of FIG. 3D, may also be applied to other crosstalk suppression setups (e.g. those illustrated in FIGS. 2A, 3B-C). Variations of the embodiment of FIG. 3D include, but are not limited to: having the measuring circuit and the adaptive cross feed impedance in the audio rendering device and measuring the output impedances, measuring the output impedances and having adaptive compensation impedances, measuring also the common reference voltage impedance (e.g. at a microphone input by measuring an echo if the microphone shares the same common reference voltage impedance), or any combination thereof.

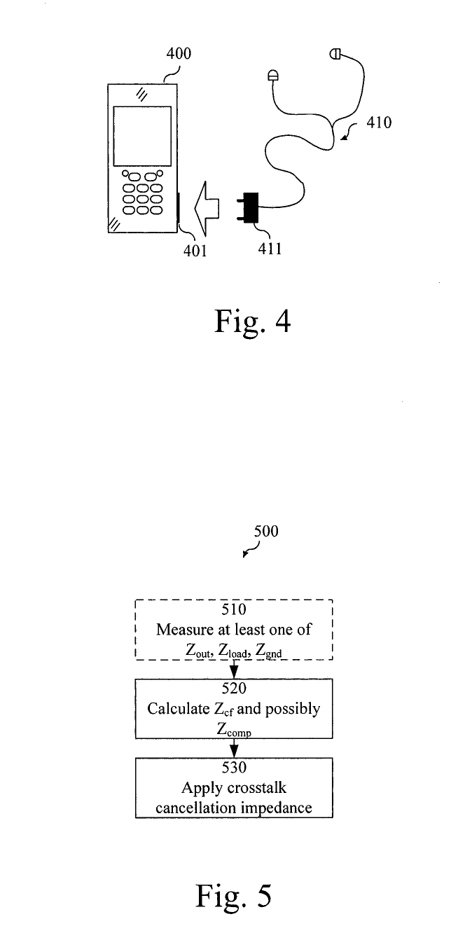

FIG. 4 illustrates an example mobile terminal 400 and a personal hand free device 410. The mobile terminal 400 comprises an audio input/output port (socket) 401 which is connectable to a corresponding audio plug 411 of the personal hands free device 410. The mobile terminal and/or the personal hands free device may comprise a crosstalk suppression arrangement according to embodiments of the invention (e.g. any of the embodiments described in connection with FIGS. 2A, 3A-D). The crosstalk suppression arrangement may be fully comprised in the mobile terminal, fully comprised in the personal hands free device, or it may be partly comprised in the mobile terminal and partly comprised in the personal hands free device.

FIG. 5 illustrates an example method 500 for a stereo audio system according to some embodiments of the invention.

In optional step 510 impedance values of one or more of the output impedances, the load impedances and the ground impedance are estimated via measurements.

In some embodiments, step 510 is performed each time an audio rendering device is connected (plugged in) to an audio processing device. This may particularly be the case if the cross feed impedance (and/or the compensation impedances if applicable) is adaptive. In some embodiments, step 510 is performed in association with the manufacturing of the devices. In some embodiments, step 510 is simply not performed and predetermined impedance values (e.g. values of the load, output and ground impedances listed in a product specification) are used in the following steps. Naturally, predetermined values may be used for some of the impedances and measurements may be performed (at manufacturing and/or at each connection instant) for some of the other impedances.

In step 520, the impedance values of the cross feed impedance is calculated. Step 520 may also comprise calculating the value of the compensation impedances if applicable. For example, any of the equations disclosed above may be used in the calculations of step 520. The calculations of step 520 are carried out based on values measured in step 510 and/or on pre-determined values. Step 520 may be performed in association with manufacturing and/or at each connection instant, depending on the situation of the particular embodiment.

Finally, in step 530, a crosstalk cancellation arrangement is applied to the audio system, where a cross feed impedance and possibly compensation impedances are used having the impedance values calculate din step 520.

The described embodiments of the invention and their equivalents may be realised in software or hardware or a combination thereof. They may be performed by general-purpose circuits associated with or integral to an audio processing or rendering device, or by specialized circuits such as for example application-specific integrated circuits (ASIC) or by discrete components. All such forms are contemplated to be within the scope of the invention.

Embodiments of the invention provide a low cost crosstalk suppression implementation. Some embodiments of the invention are not dependent on digital signal processing. Thus, those embodiments are applicable also during, for example, FM radio listening in a purely analog loop mode.

The invention may be embodied within an electronic apparatus comprising circuitry/logic or performing methods according to any of the embodiments of the invention. The electronic apparatus may, for example, be a portable or handheld mobile radio communication equipment, a mobile radio terminal, a mobile telephone, a communicator, an electronic organizer, a smartphone, a computer, a notebook, a mobile gaming device, a personal hands free device, headphones, a pair of earphones or a single earphone.

The invention has been described herein with reference to various embodiments. However, a person skilled in the art would recognize numerous variations to the described embodiments that would still fall within the scope of the invention. For example, it should be noted that in the description of embodiments of the invention, the partition of functional blocks into particular units is by no means limiting to the invention. Contrarily, these partitions are merely examples. Functional blocks described herein as one unit may be split into two or more units. In the same manner, functional blocks that are described herein as being implemented as two or more units may be implemented as a single unit without departing from the scope of the invention.

Hence, it should be understood that the limitations of the described embodiments are merely for illustrative purpose and by no means limiting. Instead, the scope of the invention is defined by the appended claims rather than by the description, and all variations that fall within the range of the claims are intended to be embraced therein.

1. A crosstalk suppression arrangement for a stereo audio system, wherein the stereo audio system comprises a left stereo channel and a right stereo channel, each comprising a driving circuit, an output impedance of the driving circuit comprising at least a first output impedance part and a load impedance connected in series with the output impedance, and wherein the load impedances of the left and the right stereo channels are connected to a reference voltage via a common reference voltage impedance, the crosstalk suppression arrangement comprising:
a crosstalk suppression impedance having an impedance value which is based on the reference voltage impedance, at least one of the load impedances and at least one of the output impedances, wherein the crosstalk suppression impedance is connected at one end to a point between the load impedance and the output impedance of the left stereo channel and at another end to a point between the load impedance and the output impedance of the right stereo channel.

2. The crosstalk suppression arrangement of claim 1, wherein the impedance value, Z_{cf}, of the crosstalk suppression impedance satisfies
Z_{cf}=f₁(Z_{load,L};Z_{load,R})f₂(Z_{out,L};Z_{out,R})/Z_{g},
where f₁ is a first mathematical function, f₂ is a second mathematical function, Z_{load,L} and Z_{load,R} denote the load impedances of the left and right stereo channel respectively, Z_{out,L} and Z_{out,R} denote the output impedances of the left and right stereo channel respectively, and Z_{g} denotes the reference voltage impedance.

3. The crosstalk suppression arrangement of claim 2, wherein each of the first and second mathematical functions comprises one of:
a maximum function, f(x,y)=max(x,y);
a minimum function, f(x,y)=min(x,y); and
an average function, f(x,y)=(x+y)/2.

4. The crosstalk suppression arrangement of claim 1, further comprising one or more sensors adapted to measure at least one of the output impedances, the load impedances, and the reference voltage impedance, and wherein the crosstalk suppression impedance is an adaptive impedance.

5. The crosstalk suppression arrangement of claim 1, wherein each of the output impedances further comprises a second output impedance part in series with the first output impedance part.

6. The crosstalk suppression arrangement of claim 1, further comprising the first output impedance parts of the left and right stereo channels.

7. The crosstalk suppression arrangement of claim 5, further comprising one or more output impedance sensors adapted to measure the second output impedance parts, and wherein the first output impedance parts are adaptive impedances.

8. The crosstalk suppression arrangement of claim 1, wherein the crosstalk suppression impedance comprises a first crosstalk suppression impedance part in parallel with a second crosstalk suppression impedance part.

9. An audio rendering device comprising the load impedances of the left and the right stereo channels and the crosstalk suppression arrangement of claim 1.

10. An audio rendering device comprising the load impedances of the left and the right stereo channels and the first crosstalk suppression impedance part of claim 8.

11. The audio rendering device of claim 9, wherein the audio rendering device is one of: a personal hands free device and a headphone device.

12. An audio processing device comprising the driving circuits of the left and right stereo channels and the crosstalk suppression arrangement of claim 1.

13. An audio processing device comprising the second crosstalk suppression impedance part of claim 8.

14. The audio processing device of claim 12, wherein the audio processing device is a mobile communication device.

15. A method to suppress crosstalk for a stereo audio system, wherein the stereo audio system comprises a left stereo channel and a right stereo channel, each comprising a driving circuit, an output impedance of the driving circuit comprising at least a first output impedance part and a load impedance connected in series with the output impedance, and wherein the load impedances of the left and the right stereo channels are connected to a reference voltage via a common reference voltage impedance, the crosstalk suppression method comprising:
applying a crosstalk suppression impedance having an impedance value which is based on the reference voltage impedance, at least one of the load impedances and at least one of the output impedances, between a connection point between the load impedance and the output impedance of the left stereo channel and a connection point between the load impedance and the output impedance of the right stereo channel.

16. The method of claim 15, further comprising calculating the impedance value, Z_{cf} as
Z_{cf}=f₁(Z_{load,L};Z_{load,R})f₂(Z_{out,L};Z_{out,R})/Z_{g},
where f₁ is a first mathematical function, f₂ is a second mathematical function, Z_{load,L} and Z_{load,R} denote the load impedances of the left and right stereo channel respectively, Z_{out,L} and Z_{out,R} denote the output impedances of the left and right stereo channel respectively, and Z_{g} denotes the reference voltage impedance.

17. The method of claim 15, further comprising measuring at least one of the output impedances, the load impedances, and the reference voltage impedance, and calculating the crosstalk suppression impedance value based on the measurement.
